(19) United States
(12) Patent Application Publication
(10) Pub. No.: US 2006/0000545 A1
(43) Pub. Date: Jan. 5, 2006

(54) Process for manufacturing a packaging material

(75) Inventors: Hans Rudolf Nageli, Neuhausen (CH); Franz Peter Hombach, Beringen (CH)

Correspondence Address: FISHER, CHRISTEN & SABOL, 1725 K STREET, N.W., SUITE 1108, WASHINGTON, DC, 20006, US

(73) Assignee: ALCAN TECHNOLOGY & MANAGEMENT LTD.

(21) Appl. No.: 11/169,885

(22) Filed: Jun. 30, 2005

(30) Foreign Application Priority Data
Jul. 1, 2004 (EP) 04405404.7

(51) Int. Cl. B29C 65/14

(52) U.S. Cl. 156/272.2

(57) ABSTRACT

A process for manufacturing a sterilizable packaging material is such that a film or foil is printing on, the printing (11) coated with an electron-beam-curable material and the outer layer (12) radiated with electrons to cure-harden the coating material. The laminate is particularly well suited for manufacturing sterilizable packaging for foodstuffs or pharmaceutical products. The production of the laminate using electron-beam-curable outer layers results in a significant reduction in throughput time and in greater flexibility in production, and to a reduction in solvent emissions on replacing solvent-based laminating with electron-beam-curable lacquers.

The invention relates to a process for manufacturing a sterilisable packaging material having a film or a foil with printing thereon. Also within the scope of the invention is a sterilisable packaging material for foodstuffs or pharmaceutical packaging, manufactured from the laminate.

Packaging materials for sterilisable pouched, self-standing pouches or lids for packaging foodstuffs or pharmaceutical products or for technical purposes are produced today as multilayer laminates in a multi-stage lamination process using solvent-free or solvent-based polyurethane (PUR) adhesives.

The lamination steps are interrupted each time before lamination with the next film/foil for an interval of time required to allow the adhesive layer applied between the films/foils in the previous step to cure-harden completely in order for them to be bonded to each other. In addition, the printing of the film forming the outer side to form an optically recognisable image has to be carried out by counter printing.

The typical final structure is: polyethylenetereplthalate (PET) film/printing/ (counterpoint)/adhesive/PET-film/adhesive/polyolefin-film as sealing layer. After the final curing over a period of several days, the completed laminate can be cut to size and sent to the customer. The throughput time required from the time of receiving the order to dispatching the cut-to-size laminate depends essentially on the time required for the PUR adhesive to harden by curing.

The object of the present invention is to provide a process of the kind described at the start, by means of which the time for curing required for the adhesive, needed for the laminating step following the printing by counterprinting, and thus the throughput time, can be reduced compared with that required for conventional laminate manufacture.

That objective is achieved by way of the invention in that the film or foil is printed on, the printing is coated with an electron-beam-curable material and the outer layer is radiated with electrons for the purpose of curing the coating material.

In conventional processes a film that is printed on by counterprinting, which forms the outer side of the packaging material, is laminated with a further film. The essence of the process according to the invention is to replace the film printed on by counterprinting by a film with normal surface printing, coating the printed film with an electron-beam-curable material and curing the outer layer by means of electron beam radiation.

The radiation curing of electron-beam-curable outer coatings and adhesives takes place within a fraction of a second on passing through a radiation unit, whereby the complete curing is essentially achieved when the laminate emerges from the radiation unit and is coiled i.e. without any additional time for curing.

A basic advantage of the process according to the invention is that the performance of packaging material production is increased as the pre-laminate can be produced in large amounts and then printed on individually and provided with an outer layer. This also increases the flexibility of the production units as smaller charges of material—as are increasingly ordered today—can be manufactured more economically.

The laminates produced using the process according to the invention have the structure: outer layer of an electron-beam-curable material/printing//pre-laminate. Examples of pre-laminates with barrier properties or sealing properties are e.g.
PET-film/barrier layer (e.g. SiOₓ)/adhesive/polyolefin-film
Aluminium foil/adhesive/sealing layer

Further developed laminates that have been manufactured by the process according to the invention have the structure: outer layer of an electron-beam-curable material/printing with electron-beam-curable printing ink/pre-laminate. Here the method of electron-beam-curing printing ink is employed in addition to electron-beam radiation of the outer layer.

The new technology according to the invention replaces structures such as
PET-film/printing ink/adhesive/PET-film/adhesive/polyolefin film
PET-film/printing ink/adhesive/PET-film/adhesive barrier layer (e.g. SiOₓ) /adhesive/polyolefin film
PET-film/printing ink/adhesive/aluminium foil/adhesive/sealing layer

The electron-beam-curable coating material is preferably an acrylate-based material.

The acrylate-based coating material may contain monomers, oligomers or mixtures of monomers and oligomers as the basis. Examples of monomers are mono-, di- and multifunctional acrylates such as phosphoric acid ester-acrylates, hydroxy-acrylates, carboxy-acrylates, amino-acrylates, acrylic acid and acryl-amide. Examples of oligomers are epoxy-acrylates, urethane-acrylates, polyester-acrylates, silicone-acrylates and silane-acrylates. The above mentioned monomers and oligomers are either available commercially or can be manufactured by routine methods. The term “acrylate” (or “acryl”) also includes “methacrylate” (or “methacryl”), whereby the acrylates are preferred.

The outer coats of an electron-beam-curable adhesive are preferably cured at a high voltage of 50 to 125 kV, in particular 70 to 100 kV, with an electron beam delivering to the surface of the laminate a radiation dosage of 10 to 50 kGy, preferably 20 to 40 kGy.

The laminate preferably exhibits two films or foils and an adhesive layer of an electron-beam-curable adhesive.

Preferred laminates exhibit the following structures:
Outer layer of an electron-beam-curable material/printing/PET-film/ barrier layer/adhesive layer/polyolefin film.
Outer layer of an electron-beam-curable material/printing/aluminium foil/adhesive layer/polyolefin film.
Outer layer of an electron-beam-curable material/electron-beam-curable printing substance/PET-film/barrier layer/adhesive layer/polyolefin film.
Outer layer of an electron-beam-curable printing substance/alumninium foil/adhesive layer/polyolefin film.

Preferred films are sealable films of polyethylene (PE) or polypropylene (PP). For sterilisable or heat-temperature cooking applications PP is to be preferred because of its higher resistance to thermal loads.

The barrier layer against gases, vapours and moisture may be in the form of a metal foil e.g. an aluminium foil. Other materials that are suitable for barrier layers are e.g. films of plastics such as polyvinylidenchloride (PVDC) or ethyl-vinyl-alcohol-copolymer (EVOH), or a layer of ceramic materials such as silicon oxide or aluminium oxide or nitride which are vacuum deposited on the substrate layer as a thin e.g. 10-500 nm thick layer. Examples of further barrier layers are metallic layers e.g. of aluminium.

In the present case metallising is also a suitable means for providing the PTE-film, and with that the packaging film, with barrier properties—thus preventing ingress of fluids, gases, vapours, water vapour, aromas or smells. A preferred form of metallising is one of aluminium which is deposited in vacuum e.g. by sputtering or precipitation to a thickness of about 10 nm to about 2 μm on the PET-film.

The laminate manufacture by the process according to the invention is particularly suitable as sterilisable packaging material for foodstuffs or pharmaceutical packaging such as pouches, self-standing pouches, lids and for technical applications such as decorative strip for automobiles or battery packs.

Further advantages, features and details are revealed in the following description of preferred examples and with the aid of the drawing which shows schematically in

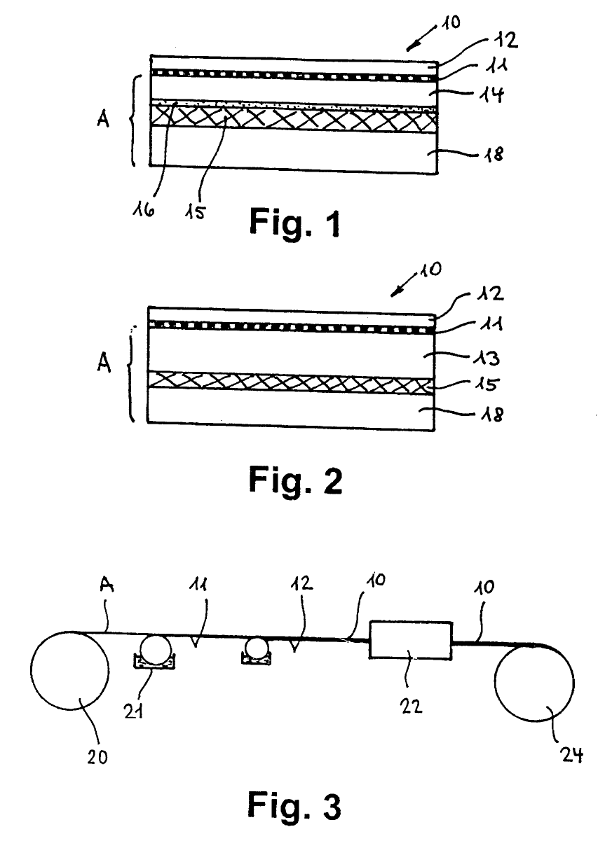

FIG. 1 cross-section through a first laminated and printed packaging film;

FIG. 2 cross-section through a second laminated and printed packaging film;

FIG. 3 manufacture of a printed packaging film from a pre-laminate.

A sterilisable packaging film 10 shown in FIG. 1 for manufacturing packaging for foodstuffs and pharmaceutical products features a PET-film 14 as outer lying layer and a sealable PE-film or PP-film 18 as inner layer. The PET-film 14 exhibits on one side printing 11 and outer layer 12 and on the other side a barrier layer 16 e.g. of SiOₓ. The side of the outer lying PET-film 14 with barrier layer 15 is bonded permanently to the inner lying sealing film 18 via an adhesive layer 15, In a typical packaging film 10 the thickness of the PET-film is e.g. 12 μm, the thickness of the PP sealing layer about 30 μm.

Shown in FIG. 2 is another version of a sterilisable packaging film 10 for manufacturing forms of packaging for foodstuffs or pharmaceutical products which exhibits the same structure as that in FIG. 1 with the exception that, instead of a PET-film 14 with barrier layer 16 as outer layer, an aluminium foil 13 is employed. In a typical packaging film 10 the thickness of the aluminium foil is e.g. about 8-12 μm, the thickness of the PP-sealing layer about 30 μm.

The outer layer 12 is of an electron-beam-curable material e.g. of acrylate basis. The ink or colourant used for the print 11 may be a conventional colourant or ink. The print may, however, also be a substance that is electron-beam-curable.

In the production of the printed packaging film 10 one normally begins with a pre-laminate (see FIGS. 1 and 2). The pre-laminate A manufactured by a conventional process is—as shown in FIG. 3—uncoiled in strip form from a first spool 20 and continuously printed on in one or more printing stations 21 arranged in line. Subsequently, the print 11 on the pre-laminate A is coated with an outer layer 12 of electron-beam-curable material. The printed and coated pre-laminate A is passed through a radiation unit 22 in which the outer layer 12, and possibly the printing material if this is of an electron-beam-curable material, is cured within a fraction of a second by electron beam radiation. On leaving the radiation unit 22 the finished packaging film 10 is coiled onto a second spool 24.

1. The process for manufacturing a sterilizable packaging material having one film or foil with printing thereon, the printing (11), coated with an electron-beam-curable material, and the outer layer (12) are radiated with electrons for the purpose of curing the coating material.

2. The process according to claim 1, wherein the electron-beam-curable coating material is an acrylate-based material.

3. The process according to claim 2, wherein the outer layer (12) of an electron-beam-hardenable material is hardened at a high voltage of 50 to 125 kV utilizing an electron beam directed at the surface of the packaging material delivering a radiation dosage of 10 to 50 kGy.

4. The process according to claim 3, wherein the packaging material exhibits at least two films (14,18) or foils (13) bonded together to form a multi-layer laminate (10) by means of an adhesive layer (15).

5. The process according to claim 4, wherein the laminate (10) exhibits two films (14,18) or foils (13) and an adhesive layer (15) which is of an electron-beam-curable adhesive.

6. The process according to claim 5, wherein the laminate (10) exhibits the following structure: outer layer (12) of an electron-beam-hardenable material/printing (11)/PET-film (14)/barrier layer (16)/adhesive layer (15)/polyolefin film (18).

7. The process according to claim 5, wherein the laminate (10) exhibits the following structure: outer layer (12) of an electron-beam-hardenable material/printing (11 )/aluminum foil (13)/adhesive layer (15)/polyolefin film (18).

8. The process according to claim 5, wherein the laminate (10) exhibits the following structure: outer layer (12) of an electron-beam-curable material/electron-beam-curable printing substance (11)/PET-film (14)/barrier layer (16)/adhesive layer (15/polyolefin film (18).

9. The process according to claim 5, wherein the laminate exhibits the following structure: outer layer (12) of an electron-beam-curable material/electron-beam-curable printing substance (11)/aluminum foil (13)/adhesive layer (15/polyolefin film (18).

10. The process according to claim 9, wherein the polyolefin film (18) is a PE-film or a PP-film.

11. The sterilizable packaging material for packaging foodstuffs or pharmaceutical products, made from a laminate (10) manufactured using the process according to claim 10.

12. The process according to claim 3, wherein the curing is done at a high voltage of 70 to 100 kV.

13. The process according to claim 3, wherein the radiation voltage is 20 to 40 kGy.

14. The process according to claim 1, wherein the outer layer (12) of an elctron-beam-curable material is cured at a high voltage of 50 to 125 kV utilizing an electron beam directed at the surface of the packaging material delivering a radiation dosage of 10 to 50 kGy.

15. The process according to claim 14, wherein the curing is done at a high voltage of 70 to 100 kV.

16. The process according to claim 14, wherein the radiation voltage is 20 to 40 kGy.

17. The process according to claim 1, wherein the packaging material exhibits at least two films (14, 18) or foils (13) bonded together to form a multi-layer laminate (10) by means of an adhesive layer (15).

18. The process according to claim 17, wherein the laminate (10) exhibits two films (14,18) or foils (13) and an adhesive layer (15) which is of an electron-beam-curable adhesive.

19. The process according to claim 18, wherein the laminate exhibits the following structure: outer layer (12) of an electron-beam-curable material/printing (11)/PET-film (14)/barrier layer (16)/adhesive layer (15)/polyolefin film (18).

20. The process according to claim 18, wherein the laminate (10) exhibits the following structure: outer layer (12) of an electron-beam-curable material/printing (11)/aluminum foil (13)/adhesive layer (15)/polyolefin film (18).

21. The process according to claim 18, wherein the laminate (10) exhibits the following structure: outer layer (12) of an elctron-beam-curable material/electron-beam-curable printing substance (11)/PET-film (14)/barrier layer (16)/adhesive layer (15)/polyolefin film (18).

22. The process according to claim 18, wherein the laminate exhibits the following structure: outer layer (12) of an electron-beam-curable material/electron-beam-curable printing substance (11)/aluminum foil (13)/adhesive layer (15)/polyolefin film (18).

23. The process according to claim 1, wherein the polyolefin film (18) is a PE-film or a PP-film.

24. The sterilizable packaging material for packaging foodstuffs or pharmaceutical products, made from a laminate (10) manufactured using the process according to claim 1.
